(19) United States
(12) Patent Application Publication
(10) Pub. No.: US 2004/0100792 A1
(43) Pub. Date: May 27, 2004

(54) Illumination device for mounting on lace or strap of footwear

(76) Inventor: Michael Alexander Trzecieski, Ottawa (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/304,686

(22) Filed: Nov. 27, 2002

(51) Int. Cl. F21V 21/08

(52) U.S. Cl. 362/103; 362/486; 362/253; 362/191; 36/137

(57) ABSTRACT

More and more people are taking the plunge to participate in outdoor sports such as inline skating, ice skating, running and biking. Unfortunately, sometimes these activities may take place at night, where the pathway may not be very visible nor the person participating in the outdoor sport. Thus, a novel lighting apparatus is proposed that facilitates easy installation and removal from various types of footwear articles. The novel lighting apparatus provides an illuminated spot in front of an individual as well as provides for visibility of the individual to others.

### FIELD OF THE INVENTION

The invention relates to the area of wearable personal light emitting devices and more specifically to the area of personal light emitting devices that are wearable on apparel having either a lace or a strap.

### BACKGROUND OF THE INVENTION

More and more people are taking the plunge to participate in outdoor sports such as inline skating, ice skating, running and biking. Unfortunately, sometimes these activities may take place at night, where the pathway may not be very visible nor the person participating in the outdoor sport. Not being visible to motorists poses quite a danger in nighttime outdoor activities. Thus, illumination devices are used in conjunction with these activities, so they are safer to the participant, when these activities are performed at night or in questionable lighting conditions.

In the prior art, many inline skate illumination devices are known, for instance U.S. Pat. Nos.: 5,588,734, entitled “Side light for in-line roller skate”, and 5,855,382, entitled “Roller skate lighting device”, both disclose a lighting device for use on roller skates and the like. Both of these provide light devices that attach to a first portion of a skate and provide a light to make a skater more visible in low light level conditions. The light bar or strip and battery portable source of electricity attached to any skate by a small strap and screw or by a strap having hook and loop type fasteners. U.S. Pat. No. 5,484,164, entitled “Roller skate lighting system” provides a lighting system that is manufactured into the skate itself. In U.S. Pat. No. 6,332,692, entitled “Roller skate light system”, a plurality of lights are mounted in a cartridge insertable within an existing wheel well upon removal of a skate wheel. Unfortunately, the prior art lighting devices require straps, or screws, or other mounting features that make mounting of the lighting devices cumbersome. Furthermore, the lighting devices equipped for use with inline skates is not easily adaptable for use with other sports footwear such as shoes or ice skates.

It is therefore an object of this invention to provide a footwear lighting apparatus that facilitates easy mounting to a plurality of different types of footwear. If is further an object of the invention to provide a footwear lighting apparatus that facilitates making a wearer of the apparatus visible to others, and one that serves to illuminates a spot in front of the wearer of the apparatus.

### SUMMARY OF THE INVENTION

In accordance with the invention there is provided a light comprising:

a housing shaped for mounting to footwear and comprising:

a first aperture for receiving a portion of one of a shoe lace and a boot strap therethrough and for engaging the portion of the one of the shoe lace and the boot strap for facilitating removable fastening of the housing adjacent the footwear,

a second aperture for receiving a light source and for directing light emitted by the light source in a first direction relative to the housing; and,

a receptacle for receiving a portable source of electricity, the housing extending transverse the first aperture for maintaining an approximately fixed orientation relative to the footwear when mounted thereto.

In accordance with the invention there is provided a method of illuminating the ground in front of an individual comprising the steps of:

providing a light;

securing a light to footwear the light directed in a generally forward direction relative to the footwear for having light emitted by the light propagate at least partially downward relative to the footwear; and,

disposing the footwear on a foot of the individual such that the light is directed generally forward direction relative to the individual for illuminating in front of the individual a surface on which the individual is.

In accordance with the invention there is also provided a method of illumination comprising the steps of:

providing a light source disposed on footwear of an individual, the light source for providing illumination;

angling the light source in a second direction with respect to the footwear when the footwear is angled in a first other direction; and,

angling the light source in the first direction with respect to the footwear when the footwear is angled in the second other direction.

### BRIEF DESCRIPTION OF THE DRAWINGS

Exemplary embodiments of the invention will now be described in conjunction with the following drawings, in which:

FIG. 1 illustrates a perspective view of an embodiment of the invention, a lace or strap mounted light for mounting to a footwear article, or strap light (SL);

FIG. 2 illustrates footwear laces penetrate through an aperture in a first portion of the SL;

FIG. 3a illustrates the second portion showing internal components;

FIG. 3b illustrates a front view of the second portion;

FIG. 4a illustrates a perspective view of a mating feature disposed between the second portion and the first portion of the SL;

FIG. 4b illustrates a front view of the mating feature disposed between the second portion and the first portion of the SL;

FIG. 5a illustrates an alternative mounting of the first portion to the laces or strap;

FIG. 5b illustrates the first portion from a bottom view, showing the orientation of the clip with respect to the first portion;

FIG. 6a illustrates the SL mounted to laces of an ice skate;

FIG. 6b illustrates the SL mounted to a strap of an inline skate;

FIG. 6c illustrates the SL mounted to laces of a running shoe;

FIG. 6d illustrates the SL mounted to a lower strap of the inline skate;

FIG. 6e illustrates the SL mounted to a lower buckle of a ski boot;

FIG. 6f illustrates the SL mounted to a buckle of a cross-country ski boot;

FIG. 7a illustrates a variation of the second portion of the SL, showing two additional light sources disposed on the second portion;

FIG. 7b illustrates the moving portion having two light sources disposed thereon;

FIGS. 8a and 8b illustrate a counterbalance mechanism provided within the SL for maintaining a substantially same orientation of the moving portion with respect to the ground when an angular deviation of the footwear occurs;

FIGS. 9a and 9b illustrate a variation of the first portion; and,

FIG. 9c, illustrates a first portion that is longer than a second portion for facilitating sliding of the second portion with respect to the first portion for positionally orienting the second portion along a length of the footwear.

### DETAILED DESCRIPTION THE INVENTION

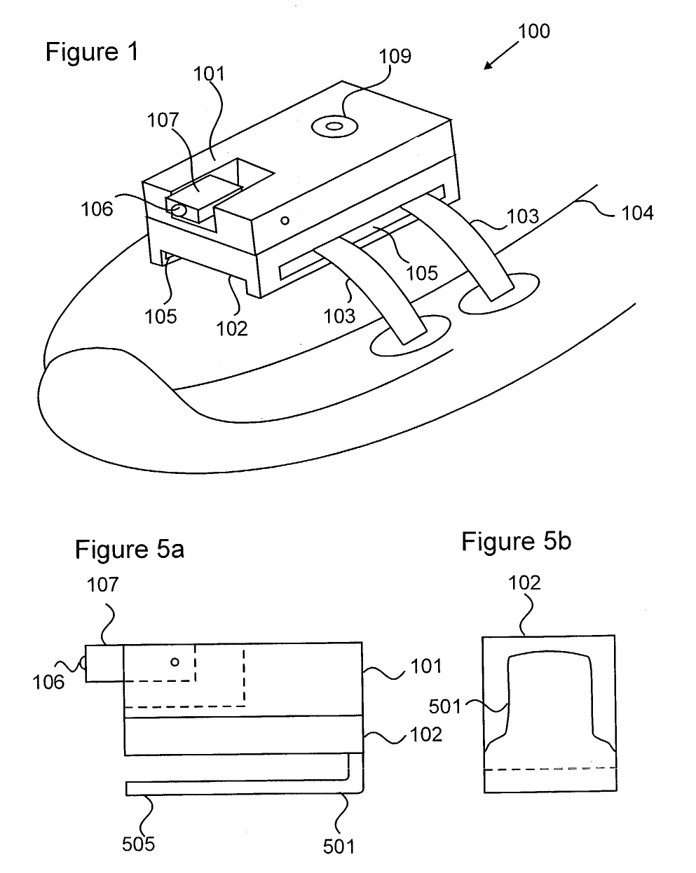

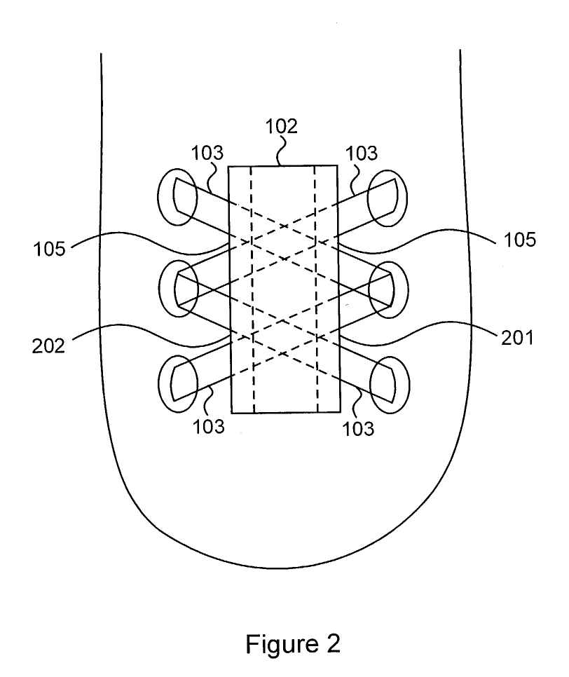

FIG. 1 illustrates a perspective view of an embodiment of the invention; a strap mounted light (SL) 100, where the straps are in the form of shoelaces. The SL 100 has a housing having a second portion 101 and a first portion 102. The first portion 102 is for mounting to a feature, in the form of laces 103, or strap, found on a piece of footwear, in the form of a shoe 104, using a first aperture 105 that preferably traverses a width of the first portion 102. The laces penetrate the first aperture (FIG. 2) from a first side to a second side, releasably securing the first portion adjacent the footwear. Of course, instead of laces, a strap disposed on the footwear is optionally used to penetrate the first aperture from a first side to a second side, thus releasably securing the first portion adjacent the footwear.

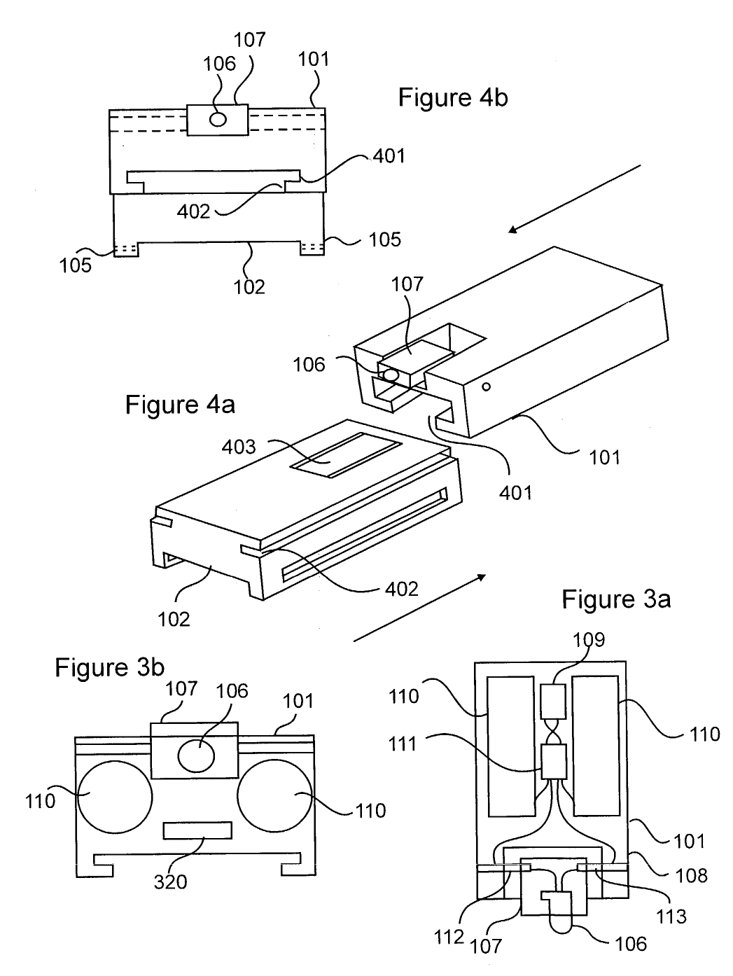

A light source 106 is disposed in a moving portion 107 that is preferably coupled to the second portion 101. Preferably, the moving portion 107 is pivotally coupled to the second portion to facilitate pivotal moving of the light source 106 about at least an axis 108 with respect to the footwear 104. The pivotal movability of the moving portion facilitates aiming of the light source 106 towards a desired direction. A switch 109 is provided in the second portion 101, the switch 109 is coupled between a portable source of electricity 110 (FIGS. 3a and 3b) and the light source 106 for switchably enabling of the light source 106 in response to actuation thereof. The pivotal mounting of the moving portion with respect to the second portion 101 advantageously provides electrical connections to the light source 106. Providing an electrical connection on each side of the moving portion 107 eliminates the need for electrical wires penetrating the moving portion 107 and the second portion 101 in order to provide power from the portable source of electricity 10 (FIG. 3a) to the light source 106.

As is shown in FIG. 2, the laces 103 of the footwear penetrate through the first aperture 105 from a first side 201 to a second side 202, preferably traversing a width of the first portion 102. The laces 103 thus hold the first portion 102 adjacent the footwear 104 when the footwear 104 is tied. The SL 100 assembly is thus removably fastened to the shoe using the laces.

In FIG. 3a, the second portion 101 is illustrated showing internal components. The switch 109 is electrically coupled to a control circuit 111, which is further electrically coupled to the light source 106. A portable source of electricity 110, in the form of batteries, is further electrically coupled to the control circuit 111. The portable source of electricity being preferably disposed within a receptacle disposed within the second portion. Thus, upon actuation of the switch 109 the portable source of electricity is electrically coupled through the control circuit to the light source 106, enabling light to be emitted from the light source in a direction determined by an orientation of the moving portion 107 about the at least an axis 108. In FIG. 3b a front view of the second portion 101 is shown. A first electrical connection is provided to the light source through a left pivot 112 and a second electrical connection is provided to the light source through a right pivot 113. The left pivot 112 and the right pivot 113 are oriented along a same axis and provide the pivotal mounting of the moving portion 107 to the second portion 101.

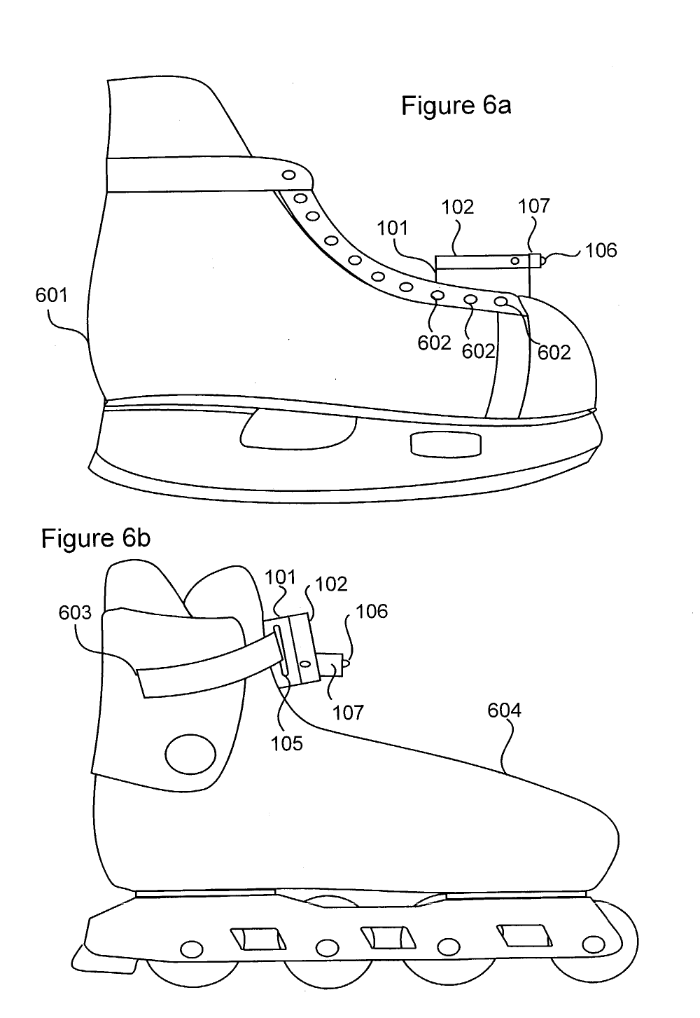

In FIG. 4a, a mating feature is shown between the second portion 101 and the first portion 102. The mating feature is in the form of an inner track 401 disposed in the second portion 101 and an outer track 402 disposed in the first portion is shown having. The inner track 401 and the outer track 402 are of such a configuration that they mate with each other to permit sliding motion of the second portion with respect to the first portion along a linear direction. A releasable locking mechanism 403 is provided between the second portion 101 and the first portion 102 for releasably locking the second portion 101 with respect to the first portion 102. FIG. 4b illustrates a front view of the second portion 101 and the first portion 102 as well as the inner and outer tracks, 401 and 402.

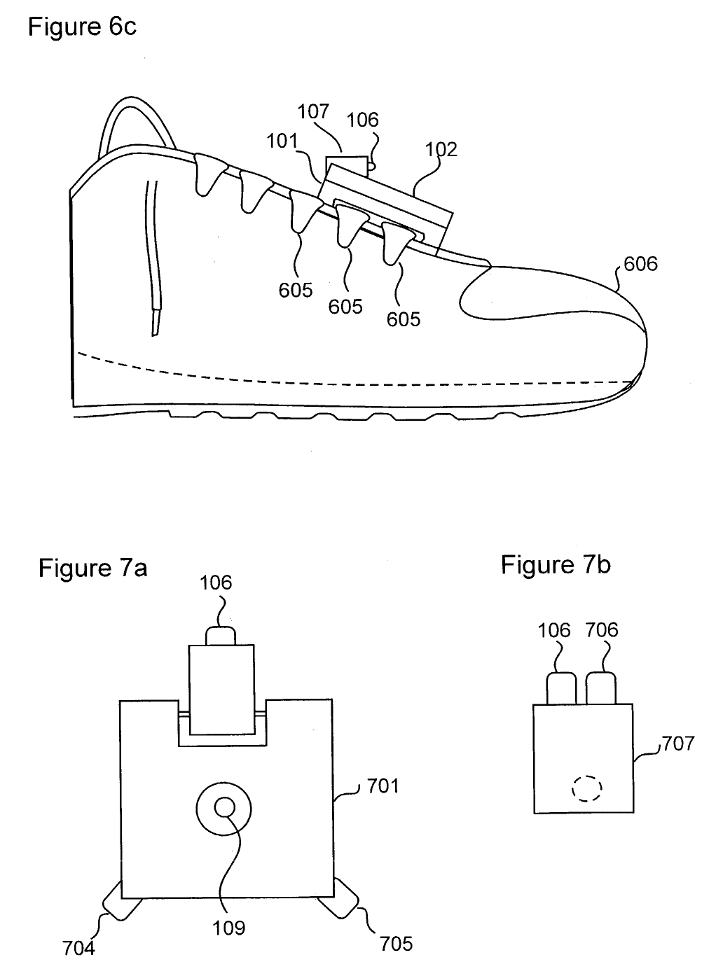

In FIG. 5a an alternative mounting is shown for the first portion 102 to the laces. In this case, a clip 501 is disposed on the first portion. The clip provides a first aperture 505 between the clip 501 and adjacent first portion 101. With the clip, the first aperture 505 is open at an end preferably proximate the light source side. The clip 501 is for engaging the lace 103 or other form of strap that is disposed within the first aperture 505. FIG. 5b illustrates the first portion 102 from a bottom view, showing the orientation of the clip with respect to the first portion.

Having the outer track 402 and the inner track 401 facilitates removal of the second portion 101 with respect to the first portion, while the first portion remains releasably attached to the footwear 104. This allows for multiple first portions 102 to be used in conjunction with a single second portion 101. This facilitates swapping of a single second portion 101 between multiple different footwear articles that each have the releasably attached first portion 102 releasably attached thereto. This advantageously eliminates the need for removing of the first portion from a footwear article if another footwear article is preferred for use, as long as the another footwear article has a releasably attached first portion releasably attached thereto. Of course, in some cases the first portion may be removed from the footwear article and releasably attached to the different footwear article.

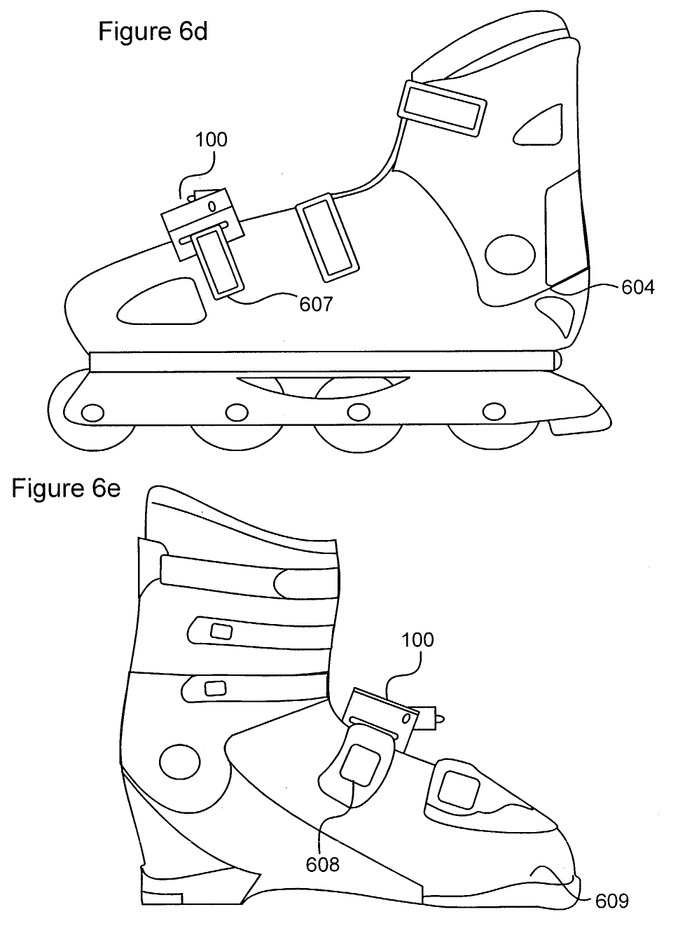

In FIG. 6a, the SL 100 is shown mounted to laces 602 of an ice skate 601. In FIG. 6b, the SL 100 is shown mounted to an upper strap 603 of an inline skate 604. The upper strap 603 penetrates the first aperture 105 of the SL 100 to facilitate mounting of the first portion of the SL adjacent the inline skate 604. In FIG. 6c, the SL 100 is shown mounted to laces 605 of a running shoe 606. In FIG. 6d, the SL 100 is shown mounted to a lower strap 607 of the inline skate 604. In FIG. 6e, the SL 100 is shown mounted to a lower buckle 608 of a ski boot 609. In FIG. 6f, the SL 100 is shown mounted to a buckle 610 of a cross-country ski boot 611. Because, in some cases it may be necessary to ski in reduced lighting conditions and thus having a light source to partially illuminate a path in front of a skier may be advantageous, especially when skiing through a forest at night.

Of course, the SL is mounted to a strap or laces using the first aperture formed in the first portion or alternatively using the clip that forms the first aperture. The clip of course forms a first aperture but it facilitates removal and installation of the first portion with respect to the laces or strap without having to remove the laces from their respective holes in the footwear, or not having to remove the strap from its respective engagement feature on the footwear. The clip facilitates loosening of the strap or laces and allows for sliding of the clip under the laces or strap where subsequent tightening thereof frictionally engages a surface of the clip proximate the first portion thus securing the SL to the footwear article.

Optionally a small generator 320 (FIG. 3b) is provided within preferably the second portion, or optionally the first portion. The small generator is for converting mechanical energy, resulting from: walking, or running or skating, or general movement of the footwear, into electrical energy for use in powering of the light source, or for storage in the portable source of electricity. Thus, with sufficient physical movement of the SL 100, the generator disposed therein generates sufficient electrical energy to power the light source while using minimal energy stored in the portable source of electricity. For instance the generator may be in the form of a pager motor having an unbalanced weight disposed on an armature thereof. Physical motion of the armature preferably causes electricity to be generated by the pager motor resulting in charging and powering of the SL 100. Of course, the generator may optionally be disposed within the receptacle in the second portion and preferably coupled to the portable source of electricity.

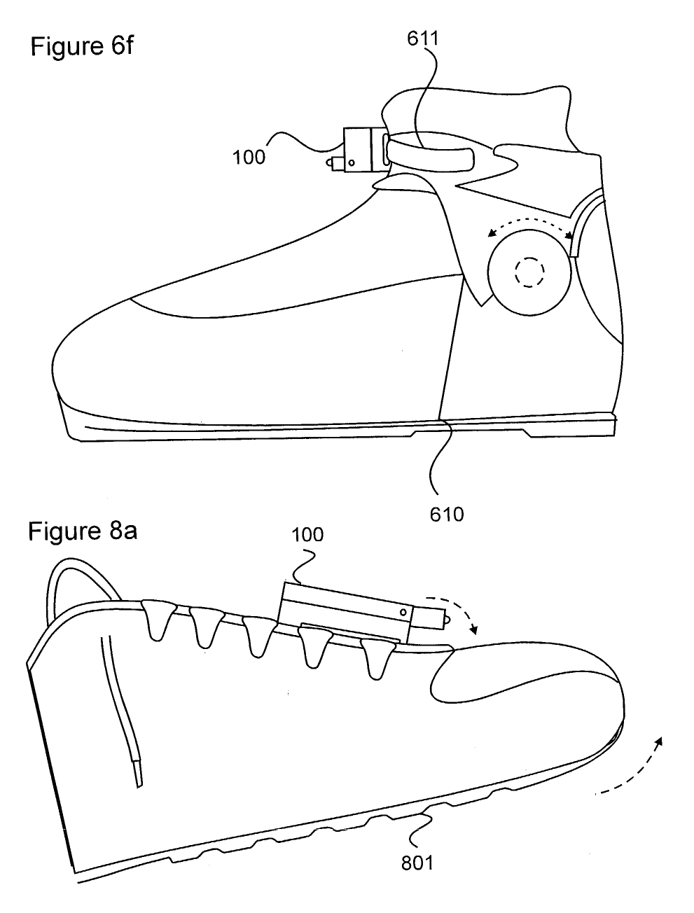

In FIG. 7a, a variation of the second portion 701 is shown. The dual light sources coupled to the control circuit for switchably turning on and off thereof using the switch 109. Additional light sources 704 and 705 are provided on the second portion 701, at an end thereof opposite the light source 106. Preferably, the light sources 704 and 705 emit light of a different color than light source 106. For instance, a light source that emits white light is chosen for light source 106 and light sources that emits red light are chosen for light sources 704 and 705. This advantageously provides an indication to others as to a direction of motion of a wearer of the SL 100. In FIG. 7b a variation of the moving portion 707 is shown having dual light sources 106 and 706.

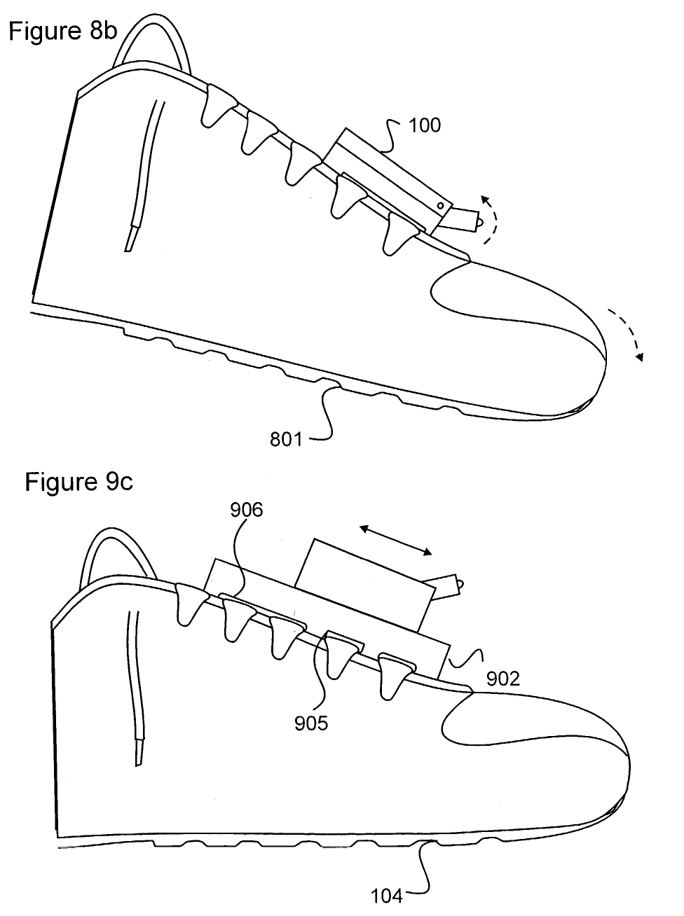

Further optionally, the moving portion 107 is counterbalanced about the at least an axis 108 for enabling reduced movement of the moving portion 107 in response to movement of the second portion 101, as is shown in FIGS. 8a and 8b. Thus for example, if the SL 100 is mounted to footwear 801 worn by a person jogging, a beam emitted by the light source 106 travels in a substantially reduced vertical displacement in response to the footwear being lifted by the jogger, as shown in FIG. 8a. In this case the footwear is shown at a position that is inclined upwards, however the moving portion is inclined downward in response to the upward motion of the footwear. In FIG. 8b, the footwear is shown moving in downwards direction, thus as the footwear moves downwards the counterbalance of the moving portion causes the moving portion to move in a substantially opposite direction. The directions upward and downward of course meaning away from and towards a common ground surface, respectively. The movement of the moving portion in the opposite direction to the vertical displacement of the footwear results in the beam of light emitted from the light source to preferably illuminate a spot that is substantially at a same distance from the person wearing the footwear since substantial vertical displacement of the spot is reduced by the counterbalance. Thus for instance, if the SL 100 is used on footwear that is used by someone who is biking, then the counterbalance enables the spot projected by the light source to be substantially at a same level in front of the person riding the bike, without substantial vertical displacement of the spot. The counterbalance preferably maintains the spot in a substantially same orientation with respect to a ground surface in response to pivotal movement of the footwear. Optionally, the counterbalancing mechanism is engaged or disengaged. When disengaged the moving portion remains in a fixed position as set by an individual. When engaged, the moving portion is free to move in response to the counterbalancing thereof.

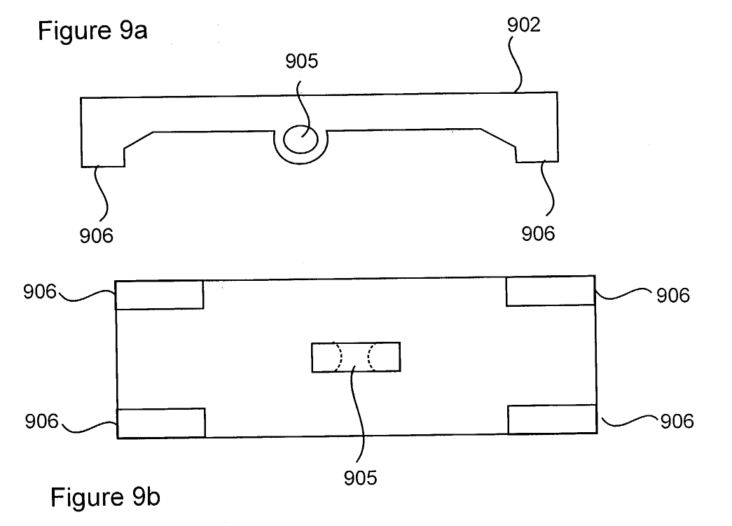

In FIGS. 9a and 9b, a variation of the first portion 902 is shown. In this case a first aperture 905 is disposed on the first portion 902 at preferably an approximate geometric center thereof. At least a contact point 906 is provided on the first portion 902 adjacent the footwear 104. The at least a contact point 906 serves to maintain the first portion 902 in a substantially fixed orientation when at least a lace and strap is threaded into the first aperture 905 (FIG. 9c). As is shown in FIG. 9c, providing a first portion 902 that is longer than the second portion 101 releasably coupled thereto permits sliding of the second portion 101 with respect to the first portion 902 along the tracks disposed in each portion. This facilitates optimum positioning of the second portion 101 with respect to the footwear 104.

Advantageously, the SL allows for easy mounting to laces or straps of footwear. This advantageously allows for using the footwear with the SL in low light conditions where having an illuminated path is preferably. It allows for illuminating of a path without holding the light source in the hands of an individual, thus making their hands free for other tasks. Further advantageously, having a bright light source for illuminating the path and having two other subsequent light sources disposed in alternate orientations allows for others to easily determine an orientation of the individual, thus allowing for enjoyment of nighttime activities while providing visibility to motorists.

Further advantageously, the added weight of the SL at a toe portion of the shoe serves to increase a weight on the toe portion of the shoe and hence when a person wearing the shoe walks the weight of the SL helps to exercise the shin muscle during lifting motion of the front portion of the shoe.

Of course, since the first portion of the SL is preferably attached to a plurality of footwear articles, it facilitates removing of the second portion of the SL between different footwear articles without having to remove laces or straps from the first aperture within the first portion. The locking mechanism facilitates simplified removal of the second portion for swapping between the various footwear articles.

Numerous other embodiments may be envisaged without departing from the spirit scope of the invention.

What is claimed is:

1. A light comprising:
a housing shaped for mounting to footwear and comprising:
a first aperture for receiving a portion of one of a shoe lace and a boot strap therethrough and for engaging the portion of the one of the shoe lace and the boot strap for facilitating removable fastening of the housing adjacent the footwear,
a second aperture for receiving a light source and for directing light emitted by the light source in a first direction relative to the housing; and,
a receptacle for receiving a portable source of electricity, the housing extending transverse the first aperture for maintaining an approximately fixed orientation relative to the footwear when mounted thereto.

2. A light according to claim 1, comprising a light source disposed within the second aperture.

3. A light according to claim 2, wherein the first direction relative to the housing is a direction for resulting in light emitted by the light source when the light is mounted to footwear being directed forward of the footwear.

4. A light according to claim 2, wherein the first direction relative to the housing is a direction for resulting in light emitted by the light source when the light is mounted to footwear being directed forward and down relative to the footwear.

5. A light according to claim 1, wherein the housing comprises a first portion including the first aperture and a second portion including the second aperture.

6. A light according to claim 5, wherein the first portion and the second portion are releasably coupled.

7. A light emitting apparatus according to claim 6, wherein both the second portion and the first portion comprise a mating feature, the mating feature for facilitating releasable coupling of the first portion to the second portion.

8. A light emitting apparatus according to claim 7, wherein mating feature comprises a track in the second portion and a track in the first portion, the tracks for mating with each other and for facilitating releasable coupling of the first portion with respect to the second portion.

9. A light emitting apparatus according to claim 7, wherein mating feature comprises a track in the second portion and a track in the first portion, the tracks for mating with each other and for facilitating slidably moving the second portion relative to the first portion along the tracks and for releasably securing the first portion to the second portion at a position along the track in the first portion.

10. A light emitting apparatus according to claim 7, comprising: a releasable locking mechanism, the releasable locking mechanism for releasably locking the second portion with respect to the first portion.

11. A light emitting apparatus according to claim 5, wherein the second portion is pivotally mounted with the first portion.

12. A light emitting apparatus according to claim 5, wherein the second portion includes a pivot for supporting pivotal motion of the second aperture therein with respect to the second portion about at least an axis.

13. A light emitting apparatus according to claim 12, wherein the pivotal mounting comprises a left pivot and a right pivot, the left pivot for propagating an electrical signal having a first polarity from the portable source of electricity and the right pivot for propagating an electrical signal having a second other polarity from the portable source of electricity, the light source having first and second electrical connections for coupling to the left and right pivots.

14. A light emitting apparatus according to claim 12, comprising: a counterbalance mechanism, the counterbalance mechanism for substantially equally balancing the second aperture about a center thereof about the at least an axis.

15. A light emitting apparatus according to claim 1, comprising: an electric generator, the electric generator disposed within the receptacle in the second portion and coupled to the charge storage device for receiving mechanical energy resulting from motion of the apparel and for transforming said mechanical energy into electrical energy for at least partially powering of the light emitting apparatus and for at least partial charging of the charge storage device.

16. A light emitting apparatus according to claim 2, wherein the light source comprises a plurality of light sources.

17. A light emitting apparatus according to claim 16, wherein some of the plurality of light sources emit light at different wavelengths.

18. A light emitting apparatus according to claim 16, wherein the plurality of light sources are disposed about the second portion at other than same spatial orientations about the second portion.

19. A light emitting apparatus according to claim 18, wherein a light source from the plurality is disposed on the second portion at an end that is opposite the light source.

20. A light emitting apparatus according to claim 1, wherein the first aperture is partially open at an end thereof.

21. A light emitting apparatus according to claim 1, wherein the footwear is part of a skate.

22. A light emitting apparatus according to claim 1, wherein the footwear is a shoe.

23. A light emitting apparatus according to claim 1, wherein the footwear is a ski boot.

24. A method of illumination comprising the steps of:
providing a light source disposed on footwear of an individual, the light source for providing illumination;
angling the light source in a second direction with respect to the footwear when the footwear is angled in a first other direction; and,
angling the light source in the first direction with respect to the footwear when the footwear is angled in the second other direction.

25. A method according to claim 24, wherein the angle of the light source is maintained approximately same relative to the ground when the footwear is angled in a first direction across a predetermined angular sweep.

26. A method of illuminating the ground in front of an individual comprising the steps of:
providing a light;
securing a light to footwear the light directed in a generally forward direction relative to the footwear for having light emitted by the light propagate at least partially downward relative to the footwear; and,
disposing the footwear on a foot of the individual such that the light is directed generally forward direction relative to the individual for illuminating in front of the individual a surface on which the individual is.

27. A method according to claim 26, wherein the light is secured to the footwear using one of a lace and a strap forming part of the footwear.

28. A method according to claim 27, comprising the step of performing one of tying and buckling the footwear using the one of a lace and strap.
